(19) United States
(12) Patent Application Publication
(10) Pub. No.: US 2010/0285683 A1
(43) Pub. Date: Nov. 11, 2010

(54) ELECTRICAL CONNECTOR HAVING IMPROVED LATCHING MEANS

(75) Inventor: XIAO-KANG ZHANG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/776,449

(22) Filed: May 10, 2010

(30) Foreign Application Priority Data
May 11, 2009 (CN) 200920303007.5

(51) Int. Cl. H01R 13/62

(52) U.S. Cl. 439/357

(57) ABSTRACT

An electrical connector (100) for mating with a mating connector (700) includes an insulative housing (1) defining a resisting face (115), a pair of latching members (2) assembled to the insulative housing, and a shielding shell (6) attached to the insulative housing. Each latching member has a resisting portion (21) and a latching portion (22) extending forwardly from the resisting portion for latching with the mating connector. The shielding shell is formed with a number of blocking plates disposed behind the resisting face of the insulative housing. The latching member is confined between the resisting face and the blocking plate.

### BACKGROUND OF THE INVENTION

1. Field of the Invention

The present invention relates to a connector, and more particularly to an electrical connector having a pair of latching members blocked by a plurality of shielding plates formed on the shielding shell and protected from falling off from the housing and capable of latching with a mating connector reliably. The instant invention relates to a copending application titled “ELECTRICAL CONNECTOR HAVING IMPROVED LATCHING MEMBERS” with the same inventor and the same assignee with the instant invention.

2. Description of Related Art

U.S. Pat. No. 7,604,496 issued to Takeuchi et al. on Oct. 20, 2009 discloses an electrical connector comprising an insulative housing having a base and a tongue portion, a plurality of contact terminals assembled to the insulative housing, a pair of latching members mounted at opposite sides of the insulative housing, a cable assembly electrically connected with the contact terminal, and a shielding shell attached to the insulative housing. The latching member is formed with a body portion, a cantilevered arm extending forwardly from an upper portion of the body portion, a fixing portion extending forwardly from a lower portion of the body portion, and a regulating portion extending rearwardly then upwardly from a rear portion of the body portion and resisting against the insulative housing at height direction.

The latching member could be secured in the insulative housing via the fixing portion and the regulating portion. Such a latching member has a complicated configuration.

Hence, an electrical connector having a reliable latching means is highly desired.

### SUMMARY OF THE INVENTION

Accordingly, an object of the present invention is to provide an electrical connector having a latching means comprising a pair of leaching members with simple configurations and a plurality of blocking plates protecting the latching members from loosening to urge the latching members to latch with a mating connector reliably.

In order to achieve the object set forth, an electrical connector mating with a mating connector in accordance with the present invention includes an insulative housing defining a resisting face, a pair of latching members assembled to the insulative housing, and a shielding shell attached to the insulative housing. Each latching member has a resisting portion and a latching portion extending forwardly from the resisting portion for latching with the mating connector. The shielding shell is formed with a number of blocking plates disposed behind the resisting face of the insulative housing. The latching member is confined between the resisting face and the blocking plate.

When the mating connector is completely mated with the electrical connector, the resisting portion of each latching member have a rearwardly moving trend and is blocked by the blocking plates. The latching members are prevented from falling off from the insulative housing, due to blocking plates provided on the shielding shell, rather than provided on the latching members. Therefore, the latching members have simple configurations and could latch with the mating connector reliably.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing the assembled electrical connector and the mating connector separating from the electrical connector;

FIG. 2 is a partially exploded perspective view showing the electrical connector, with an upper shell being separated from an insulative housing;

FIG. 3 is an exploded perspective view showing the electrical connector;

FIG. 4 is a cross-sectional view of the electrical connector, taken along line 4-4 of FIG. 1; and

FIG. 5 is a cross-sectional view similar to FIG. 4, when the mating connector is mating with the electrical connector.

### DETAILED DESCRIPTION OF THE PREFERRED EMBODIMENT

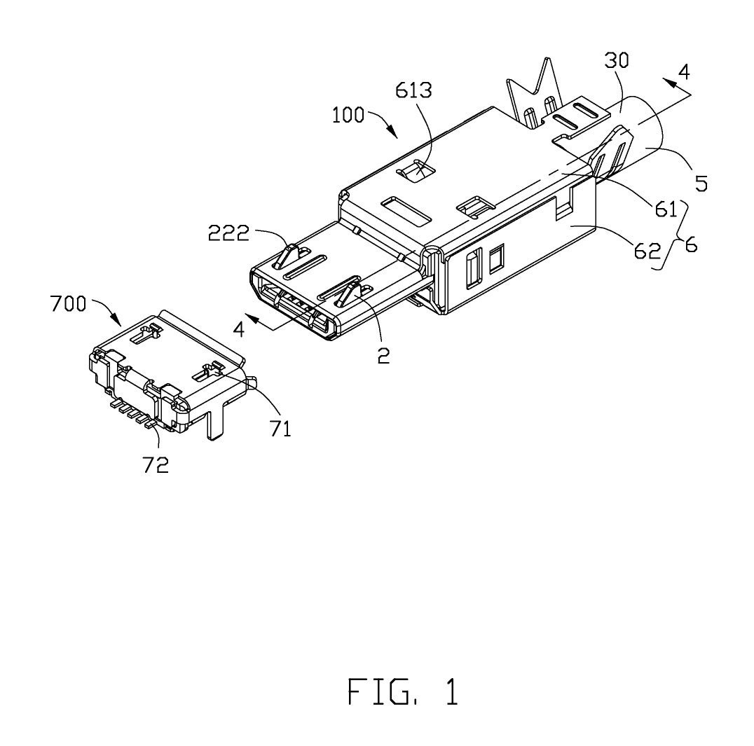

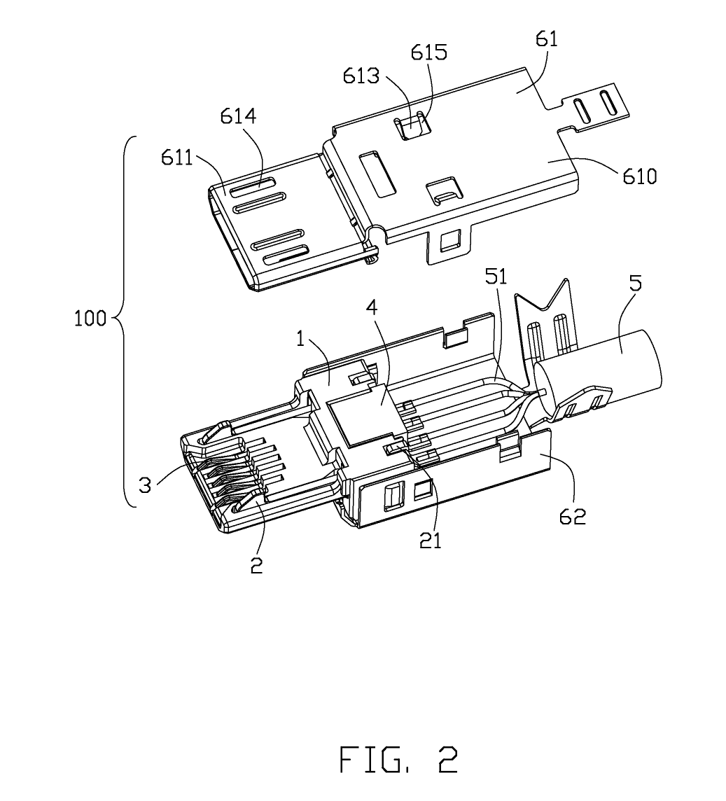

Reference will now be made in detail to the preferred embodiment of the present invention. Referring to FIGS. 1-3, an electrical connector 100 mating with a mating connector 700 comprises an insulative housing 1, a pair of latching members 2 mounted in the insulative housing 1, a cable assembly 30 assembled to the insulative housing 1, and a shielding shell 6 attached to the insulative housing 1. The mating connector 700 comprises a housing (not labeled) defining a pair of latching recesses 71 and plurality of mating contacts 72 received in the housing.

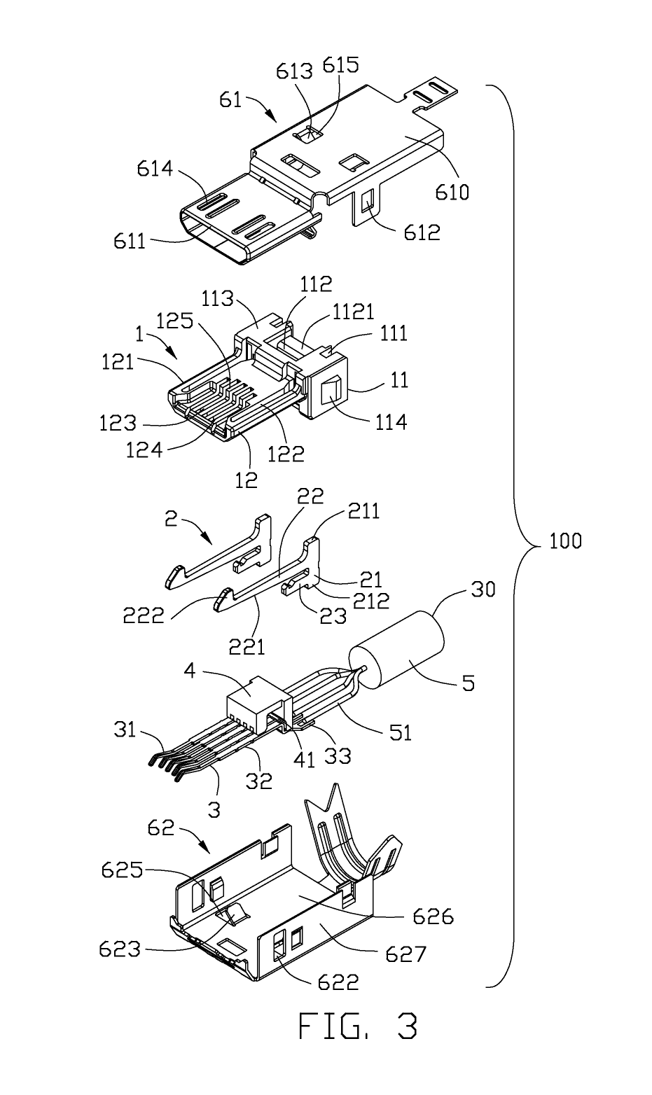

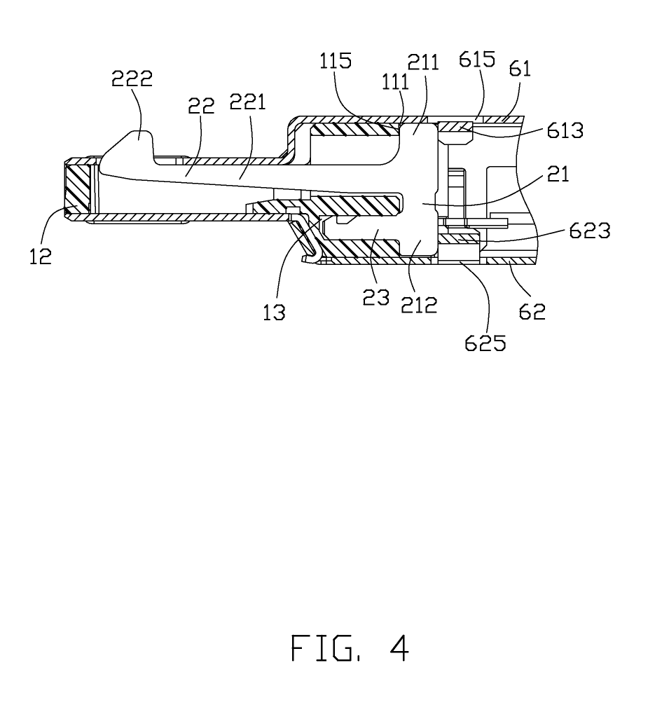

Referring to FIG. 3, the insulative housing 1 comprises a base portion 11 and a tongue portion 12 extending forwardly from the base portion 11. The base portion 11 comprises a pair of resisting walls 113 and a plunging recess 112 defined between the pair of resisting walls 113. Each resisting wall 113 has a securing recesses 111 defined along a rear surface thereof and a protrusion 114 protruding from a side face thereof. In conjunction with FIG. 4, the base portion 11 has a resisting face 115 formed in each securing recess 111 and facing toward the securing recess 111. The base portion 11 has a block 1121 formed in the plunging recess 112 and connected with the pair of resisting walls 113.

The tongue portion 12 has a pair of ribs 121 formed at a lower surface of the tongue portion 12, a stepped portion 125 between the pair of ribs 121, and a concave portion 124 defined at a front portion of the stepped portion 125. Each rib 121 is formed with an elongated inserting recess 122. The tongue portion 12 has a plurality of contact recesses 123 defined at the concave portion 124 and the stepped portion 125.

Each latching member 2 comprises a vertical resisting portion 21, a latching portion 22 substantially perpendicular to the resisting portion 21, and a barb portion 23 substantially parallel with the latching portion 22. The resisting portion 21 has a thumb portion 211 disposed above the latching portion 22, and a root portion 212 disposed below the barb portion 23. The latching portion 22 is formed with a resilient beam 221 and a hook portion 222 formed at a free end of the resilient beam 221.

The cable assembly 30 comprises an organizer 4, a plurality of contact terminals 3, and a cable 5 having a plurality of conductive portions 51. The contact terminals 3 and the conductive portions 51 of the cable 5 are connected with each other in the organizer 4. Each contact terminal 3 is formed with a contact portion 31. The organizer 4 has a opening 41 defined therein.

The shielding shell 6 comprises an upper shell 61 and a lower shell 62 cooperated with each other. The upper shell 61 comprises an upper wall 610 and a capsulate portion 611 connected with the upper wall 610. The upper wall 610 defines a pair of upper openings 615, and a pair of upper blocking plates 613 respectively extending downwardly from the upper openings 615. The capsulate portion 611 has a pair of channels 614 defined thereon.

The lower shell 62 comprises a bottom wall 626 and a pair of side walls 627. The lower shell 62 has a pair of lower openings 625 defined at the bottom wall 626 and a pair of lower blocking plates 623 respectively extending upwardly from the lower openings 625. The side wall 627 has a pair of locking holes 622 formed thereon. The upper or lower blocking plate 613, 623 is connected with the upper or lower opening 615, 625 at an edge parallel with a mating direction.

Referring to FIGS. 1-4, in assembling of the electrical connector 100, the organizer 4 is received in the plunging recess 112 of the insulative housing 1, with the block 1121 plunged in the opening 41 of the organizer 4. The contact terminals 3 are inserted in the contact recesses 123, with the contact portions 31 exposed in the concave portion 124 of the insulative housing 1. The pair of latching members 2 are received in the inserting recesses 122 of the insulative housing 1. The resisting portion 21 of the latching member 2 is disposed in the securing recess 111 of the insulative housing 1 and the barb portion 23 has an interference with the base portion 11.

The upper shell 61 and the lower shell 62 are cooperated with each other to enclose the insulative housing 1, with the capsulate portion 611 enclosing the tongue portion 12. The upper blocking plate 613 and the lower blocking plate 613 are respectively positioned behind the thumb portion 211 and the root portion 212. The hook portions 222 tilt upwardly from the inserting recesses 122 and are slidable in the channels 614 of the upper shell 61. The protrusions 114 of the insulative housing 1 engage with the locking holes 622 of the lower shell 62.

Referring to FIGS. 1 and 4, when the mating connector 700 has not been matted with the electrical connector 100, the thumb portion 211 of the latching member 2 is received in the securing recess 111. The root portion 212 of the latching member 2 is fixed between the resisting face 115 and the lower blocking plate 623.

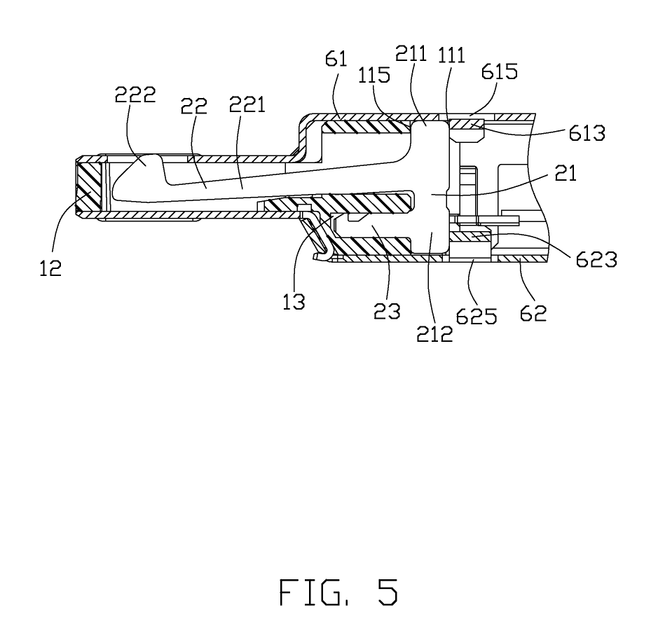

Referring to FIG. 5, when the mating connector 700 is matting with the electrical connector 100 along the mating direction, the hook portion 222 of each latching member 2 is depressed by the mating connector 700. The resilient beam 221 of the each latching member 2 is downwardly deformable.

Referring to FIG. 4, when the mating connector 700 is completely mated with the electrical connector 100, the hook portion 222 of the latching member 2 engages with the latching recess 71 of the mating connector 700, with the resilient beam 221 restoring upwardly. After suffering a resilient force generated in the resorting process of the resilient beam 221, the thumb portion 211 of the latching member 2 has a reawardly moving trend and is blocked by the upper blocking plate 613. The latching member 211 is prevented from falling off from the insulative housing 1 due to the upper blocking plate 613.

During the mating process, the root portion 212 of the latching member 2 is fixed between the resisting face 115 and the lower blocking plate 623 all along, and the thumb portion 211 of the latching member 2 is blocked by the upper blocking plate 613. The latching members 2 would be prevented from falling off from the insulative housing 1, due to the upper and lower blocking plates 613, 623 of the shielding shell 6. Therefore, the latching members 2 could latch with the mating connector 700 reliably, even after a certain period of use.

Optionally, only the pair of upper blocking plates 613 or the pair of lower blocking plates 623 are provided on the shielding shell 6, only if the upper or lower blocking plates 613, 623 could prevent the latching member 2 from falling off. Compared with providing both the upper and the lower blocking plates 613, 623 simultaneously, providing one type of blocking plates would have a weaker securing effect.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for mating with a mating connector, comprising:
an insulative housing defining a resisting face;
at least one latching member assembled to the insulative housing, said at least one latching member having a resisting portion and a latching portion extending forwardly from the resisting portion for latching with the mating connector;
a shielding shell attached to the insulative housing, said shielding shell being formed with at least one blocking plate disposed behind the resisting face of the insulative housing;
said at least one latching member being confined between the resisting face and said at least one blocking plate.

2. The electrical connector as claimed in claim 1, wherein there are two latching members, and said shielding shell comprises two blocking plates corresponding to the two latching members.

3. The electrical connector as claimed in claim 2, wherein said insulative housing defines a pair of securing recesses for insertion of the resisting portions of the pair of latching members, said resisting face being formed in each of the securing recesses.

4. The electrical connector as claimed in claim 3, wherein said resisting portion of each latching member comprises a thumb portion disposed above the latching portion, said shielding shell comprising an upper shell formed with said blocking plates, said thumb portion being blocked by said blocking plate a rearward movement.

5. The electrical connector as claimed in claim 4, wherein said upper shell defines a pair of upper openings, each of said blocking plates extending downwardly from corresponding upper opening.

6. The electrical connector as claimed in claim 5, wherein said blocking plate is connected with the upper opening at an edge thereof extending parallel with the latching portion.

7. The electrical connector as claimed in claim 3, wherein said resisting portion of each latching member comprises a root portion disposed below the latching portion, said shielding shell comprising a lower shell formed with another pair of blocking plates, said root portion being fixed between said resisting face and an associated blocking plate.

8. The electrical connector as claimed in claim 7, wherein said lower shell defines a pair of lower openings, each of said another pair of blocking plates extending upwardly from a corresponding lower opening.

9. The electrical connector as claimed in claim 3, wherein said insulative housing defines a pair of inserting recesses, and said latching portion of each latching member comprises a resilient beam received in the inserting recess and a hook portion formed at an upper front end of the resilient beam.

10. The electrical connector as claimed in claim 9, wherein said insulative housing comprises a base portion and a tongue portion extending forwardly from the base portion and formed with a pair of ribs, said pair of securing recesses being defined at the base portion, said pair of inserting recesses being respectively defined in the pair of ribs.

11. The electrical connector as claimed in claim 10, further comprising a cable assembly carrying a plurality of contact terminals, said tongue portion of the insulative housing defines a plurality of contact recesses for insertion of the contact terminals.

12. The electrical connector as claimed in claim 11, wherein said base portion of the insulative housing defines a plunging recess, and wherein said cable assembly comprises an organizer plunged in the plunging recess, and a cable having a plurality conductive portions electrically connected with said contact terminals in the organizer.

13. The electrical connector as claimed in claim 12, wherein said plunging recess of the base portion is formed with a block, and said organizer defines an opening engaging with the block.

14. An electrical connector for mating with a complementary connector, comprising:
an insulative housing defining a front mating port along a front-to-back direction;
a plurality of contacts disposed in the housing and exposed upon said mating port.
at least one latching member assembled to the inuslative housing, and defining a resisting portion, and a forwardly extending latching portion with a hook portion extending in a transverse direction perpendicular to said front-to-back direction for latching with said complementary connector; and
a metallic shield enclosing the housing, and formed unitarily with a blocking plate; wherein
said resisting portion intimately rearwardly confronts the blocking plate so as to prevent the latching member from moving rearward.

15. The electrical connector as claimed in claim 14, wherein said mating port extends horizontally, and said transverse direction is perpendicular to the mating port.

16. The electrical connector as claimed in claim 14, wherein the housing defines a rearward resisting face, and the resisting portion forwardly intimately confronts said rearward resisting face so as to preventing the latching member from forwardly moving.

17. The electrical connector as claimed in claim 16, wherein the resisting portion is located between the resisting face and the blocking plate.

18. The electrical connector as claimed in claim 16, wherein the said blocking plate is located behind the resisting face.

19. The electrical connector as claimed in claim 14, wherein said latching member is metallic and electrically conductive with the shield.

20. An electrical connector for mating with a complementary connector, comprising:
an insulative housing defining a mating port along a front-to-back direction;
a plurality of contacts disposed in the housing and exposed upon said mating port.
at least one latching member assembled to the inuslative housing, and defining a resisting portion exposed outside of the housing and a latching portion forwardly extending from said resisting portion with a hook portion projecting in a transverse direction perpendicular to said front-to-back direction for latching with said complementary connector; and
a metallic shield enclosing the housing, and formed unitarily with a blocking plate; wherein
the blocking plate defines a face forwardly intimately confronting said resisting portion so as to prevent the latching member from moving rearward, and said resisting portion defines an transverse face communicatively confronting the shell in said transverse direction.
